(19) United States
(12) Patent Application Publication
(10) Pub. No.: US 2004/0126165 A1
(43) Pub. Date: Jul. 1, 2004

(54) Print job assignment in a reconfigurable printing system

(76) Inventor: Jeremy John Carroll, Livorno (IT)

Correspondence Address: HEWLETT-PACKARD COMPANY, Intellectual Property Administration, P.O. Box 272400, Fort Collins, CO, 80527-2400, US

(21) Appl. No.: 10/632,133

(22) Filed: Jul. 30, 2003

(30) Foreign Application Priority Data
Jul. 31, 2002 (GB) 0217785.5

(51) Int. Cl. B41J 3/42

(52) U.S. Cl. 400/70

(57) ABSTRACT

The present invention relates to a system and a method that facilitates the assignment of a print job in a printing system that has one of more printers (10,11,12) connected to a computer-based printing system (1) so that the printers economically match the requirements of a print job generated by the printing system. Each printer (10,11,12) has a plurality of different printing configurations and each computer (2,3,4) is capable of generating at least one print job. Each print job has corresponding printing requirements and each printing configuration being capable of satisfying one or more printing requirements. A print job, once created, is notionally assigned across one or more of the printers (10,11,12) in such a way that the printers have printing configurations that are capable of satisfying the printing requirements. The cost for printing the print jobs is then calculated for that notional assignment. This calculation is repeated for different notional assignments, and then a preferred assignment of the, or each, print job is selected according to the calculated costs.

The present invention relates to a system and a method that facilitates the assignment of a print job in a printing system that has one of more printers connected to a computer-based printing system so that the printer(s) economically match the requirements of a print job generated by the printing system.

Modern laser printers have a large number of different properties and configuration settings. The properties are in general non-configurable attributes of the printer, such as: engine speed; presence or absence of a duplexing unit; existence of a PostScript interpreter. Configuration settings, in contrast, can be changed, for example: duplexing enabled or disabled; input tray two configured for A4 media or A3 media; input tray three containing face-up note-paper headed with “European Patent Office”.

In some environments a specific attribute may be viewed as configurable whereas in others it is viewed as non-configurable.

For example, it is possible to physically remove a duplexing unit from an HP LaserJet™ 5Si, but; it is not normal to require a printer operator to do so. Although some configuration settings may be changed automatically, for example by a command sent to a networked printer from a computer on the network, many configuration settings can only be changed manually.

The status of properties and configuration settings of a printer may be accessible through a database (known as a management information base, or “MIB”) that may be stored in the printer itself or elsewhere in the printing system.

A combination of property values and configuration settings, available at a printer, is known as a printer profile.

Print jobs, intended for such a printer, have a related set of print job selections. The set of selections are the requirements of the print job for optimal printing. This set of requirements may be described explicitly as a job ticket, as described in patent document U.S. Pat. No. 5,467,434, or implicitly by the print data, such as by the use of the duplexing escape sequence in a PCL stream.

A printer profile satisfies a print job requirement set, and the printer is adequate for the job, if all the selections specified in the job ticket are also specified, or implicit, in the printer profile.

Patent document U.S. Pat. No. 5,129,639 describes how given a print job with a job ticket and a printer profile, not adequate for the job, it is possible to modify the job ticket to have a different set of requirements that are satisfied by the printer profile.

In some cases, however, it may not be possible or desirable to modify the job ticket.

In patent documents JP 95219270, U.S. Pat. No. 5,467,434 and U.S. Pat. No. 5,625,757 it is described how, given a print job with a job ticket and the properties and configuration settings of a plurality of printers, it is possible to select a printer adequate for the print job.

However, it may be that none of the printers are adequate for the job.

According to the invention, there is provided a method of assigning a print job in a printing system, the printing system comprising at least one printer and at least one computer connected to said printer(s), wherein the or each printer has a plurality of different printing configurations and the or each computer is capable of generating at least one print job, said print job(s) having corresponding printing requirements, each printing configuration being capable of satisfying one or more printing requirements, the method comprising the steps of:

i) creating one or more print jobs;

ii) notionally assigning the or each print job across one or more of the printers in such a way that the one or more of the printers have printing configurations that are capable of satisfying the printing requirements;

iii) calculating a cost for printing the or each print job according to said notional assignment;

iv) repeating steps ii) and iii) at least once for a different notional assignment; and

v) selecting according to the calculated costs a preferred assignment of the or each print job.

The print job may then be submitted the printer(s) according to the preferred assignments( ).

The calculation of cost may be according to pure economic cost. However, it should be appreciated that such costs may be other than pure economic costs, dictated by, for example, user requirements not readily rendered in financial terms.

The complexity of the printer system may range from a single computer connected directly to a printer, to a plurality of computers connected via a network to a plurality of printers. There may for complex systems be a very large number of possible different configurations of various printers. For the main benefits of the invention to be obtained, it is not necessary for the absolute lowest cost solution to be identified, although this is of course desirable. The economic costs of various configurations may, in any event, be estimates or approximate figures. It is therefore only necessary that the selected assignment of the print job is a less than the most expensive assignment.

The printers will, in general, have a pre-existing configuration, and the calculation of the economic cost includes an assessment of the economic cost of any needed changes from the pre-existing configuration(s) to changed configuration(s) so that the printer(s) can satisfy the printing requirements.

If the needed changes to the printer reconfigurations include manual reconfiguration of a printer, the calculated economic cost should then include as assessment of the economic cost of such a manual reconfiguration. In general, manual reconfigurations will attract a higher notional economic cost than automatic reconfigurations, which can be performed directly by the computer system.

When the preferred assignment of the printing job requires a manual reconfiguration of one or more of the printers, then it is particularly helpful for a user of the system if the computer system, after selection of the preferred assignment, presents instructions to the user for manually reconfiguring one or more of the printers. Such instructions may, for example, be displayed on a visual display unit, or printed off on a local printer. The user can then use the instructions to reconfigure the printer efficiently prior to submission of the print job to the or each of the printers.

This current invention therefore assists the operator in reconfiguring the printer in an economic manner, so that the requirements of the job ticket are satisfied by the reconfigured printer.

When the print job is assigned to more than one printer, the printing system may present to a user of the printing system instructions for any or all of locating, assembling, collating, binding, or otherwise combining material printed from the printers. This helps to lower the economic cost of splitting a print job or jobs across a plurality of printers.

In general, the print job may be sent as print data from the computer system to the printers. The print data can include, either explicitly or implicitly, a job ticket for the print job.

One reason why it might be desirable to split a print job, is when the print job has a plurality of different parts, and each part has different printing requirements. The print job can then be split according to those different requirements.

Also according to the invention, there is provided a printing system, the printing system comprising at least one printer and at least one computer connected to said printer(s), the or each printer having a plurality of different printing configurations and the or each computer being capable of generating at least one print job, said print job(s) having corresponding printing requirements, each printing configuration being capable of satisfying one or more printing requirements, wherein the printing system is arranged to calculate a cost for printing the or each print job according to different notional assignments of the or each print job across one or more of the printers in such a way that said printers have printing configurations that are capable of satisfying the printing requirements, and to select according to the calculated costs a preferred assignment of the or each print job.

The print job may then be submitted to the one or more of the printers according to the preferred assignment(s).

The invention will now be described by way of example only, with reference to the accompanying drawings, in which:

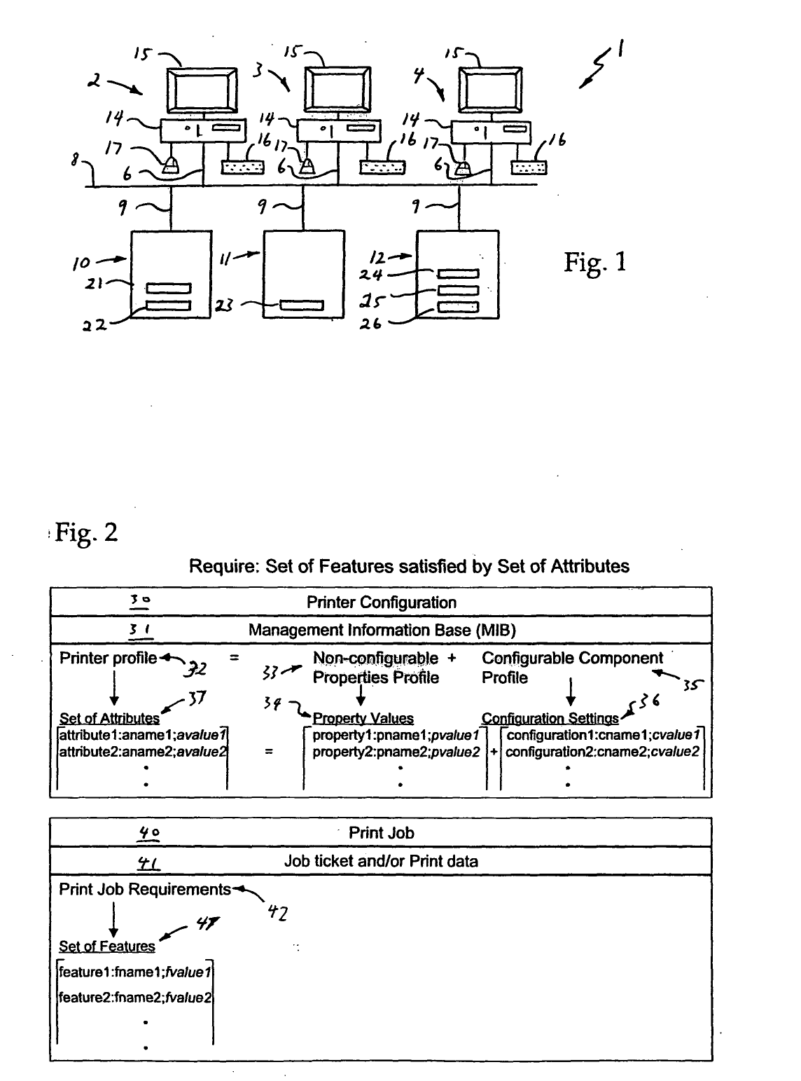

FIG. 1 is a view of a printing system according to the invention, showing several printers connected to computers via a computer network, each computer having a user display;

FIG. 2 is a schematic representation of the need to match a set of printer Attributes derived from a Printer Profile relating to one or more printers, with a Set of print job Features derived from a Job Ticket and/or Print Data to be sent to the printer(s);

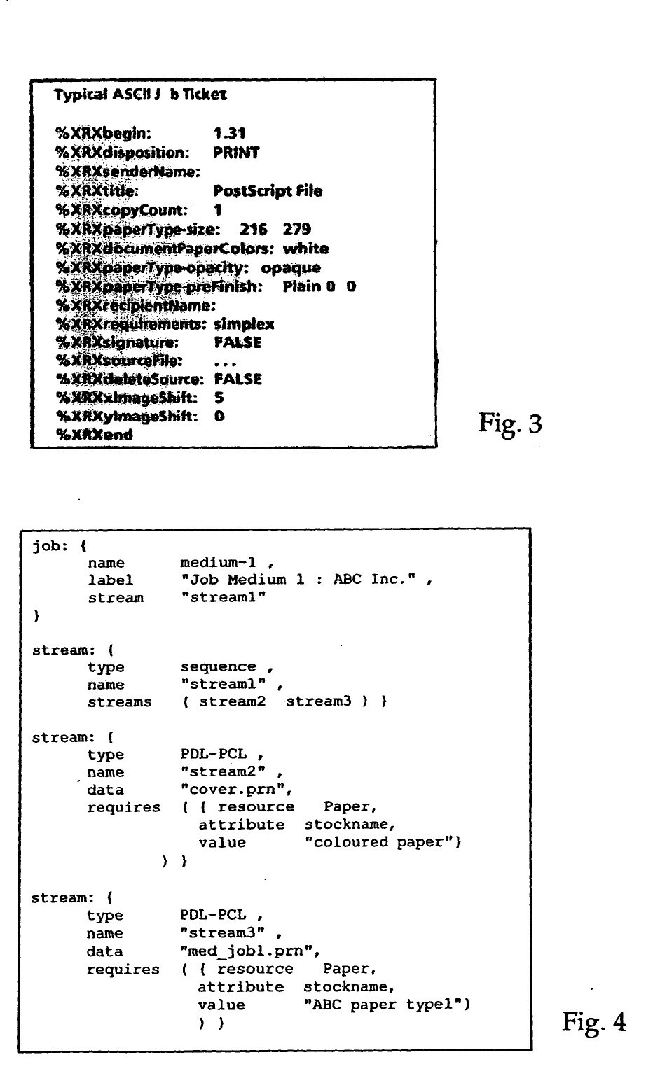

FIGS. 3 and 4 are, respectively, examples of a typical ASCII Job Ticket, and a Caxton Job Ticket, that may be used to derive the Set of Features;

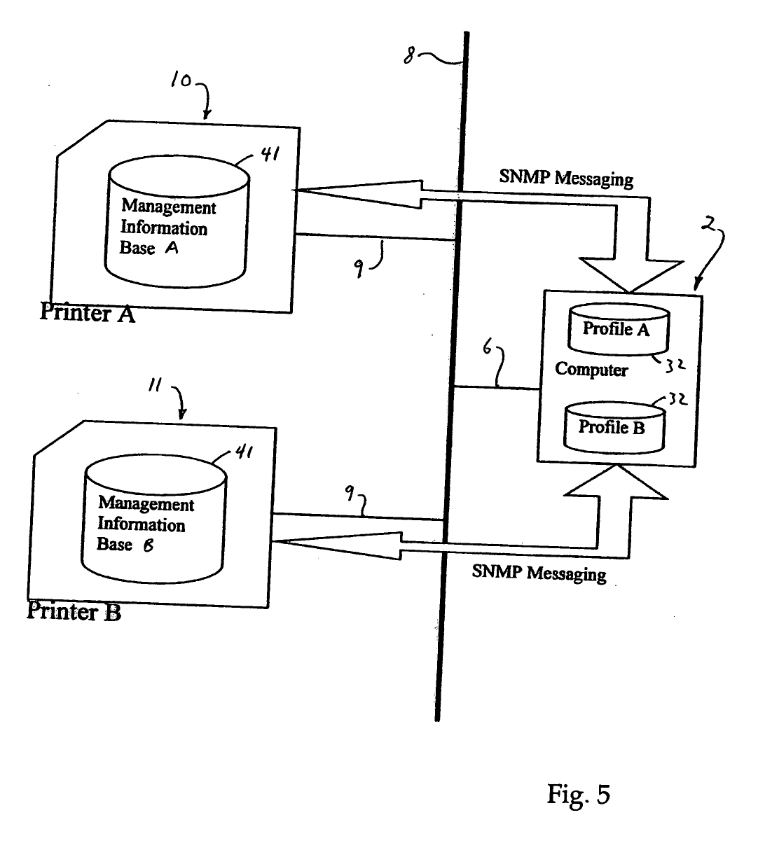

FIG. 5 shows how a computer can communicate with the printers over the network to maintain a Printer Profile in the computer that corresponds with the Management Information Base in each printer;

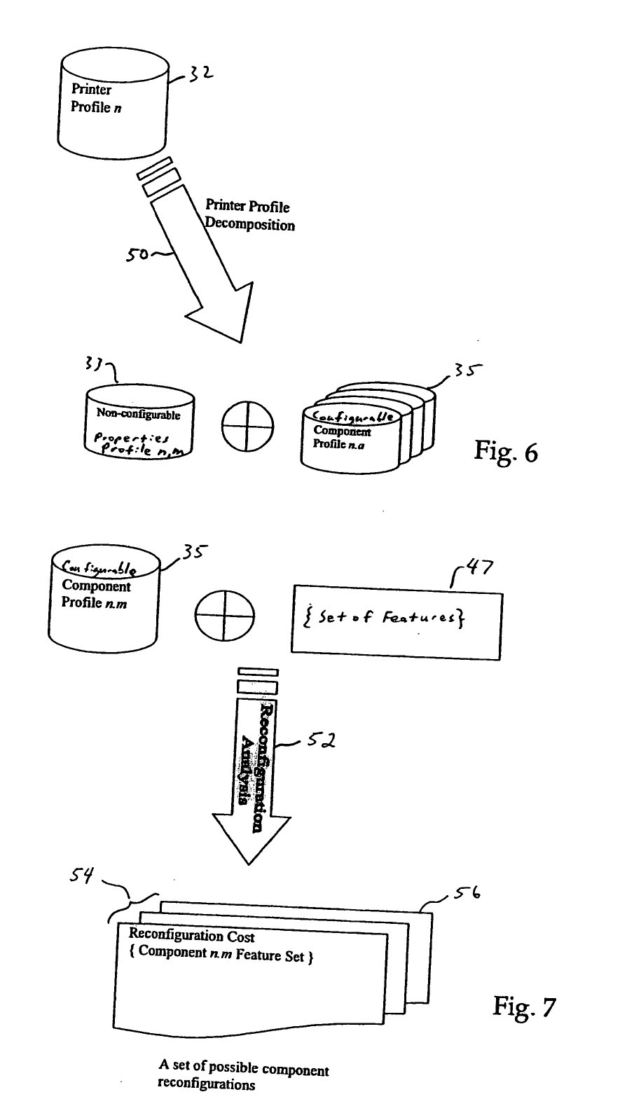

FIG. 6 shows how the computer may decompose the Printer Profile into constituent a Non-configurable Properties Profile and a Configurable Component Profile;

FIG. 7 shows schematically that the Printer Profile is combined with the Set of Features for the print job to give a plurality of a priori plausible component reconfigurations, each with an associated Reconfiguration Cost;

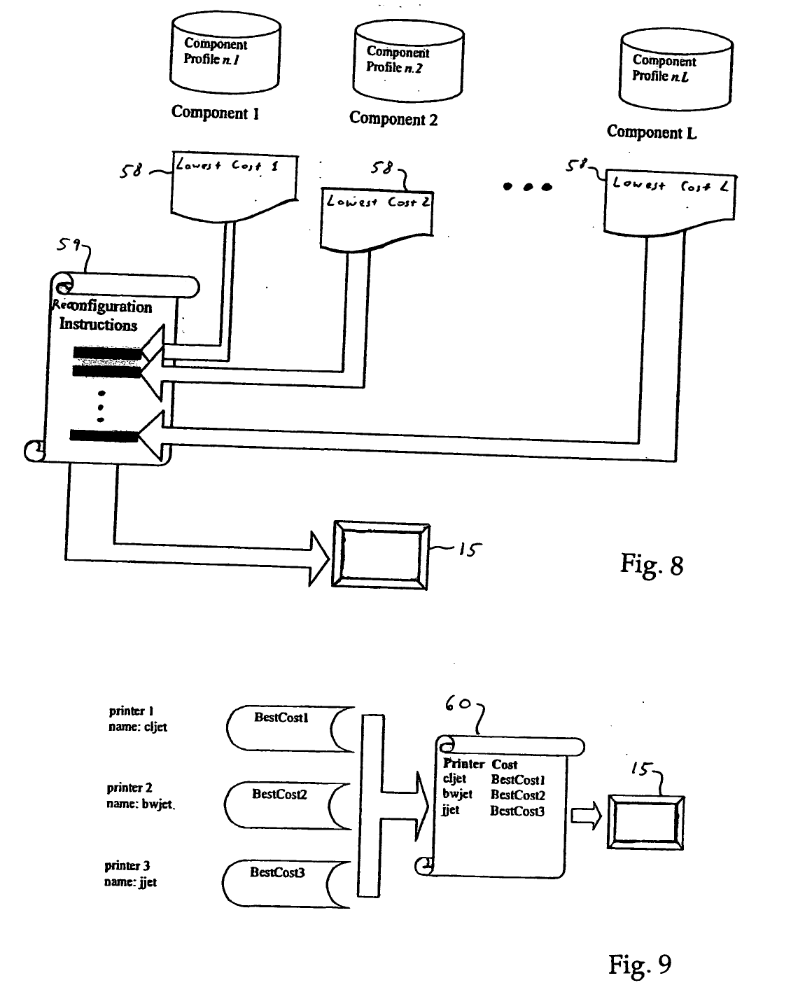

FIG. 8 shows schematically how a set of Lowest Cost component reconfigurations of corresponding Component Profiles is used to present to a user of the printing system a plurality of Reconfiguration Instructions; and

FIG. 9 shows how a plurality of Low Cost reconfiguration options can be presented to a user of the printing system, prior to the user selecting one of the options to obtain the Configuration Instructions.

FIG. 1 shows schematically a printing system 1 having several personal computers 2,3,4 each of which is connected 6 to a local area network 8. Also connected 9 to the network 8 are several printers 10,11,12, each of which has one or more trays 21-26 that can be loaded with various types and sizes of paper, transparencies, envelopes, or other types of feedstock (not shown).

Each computer 2,3,4 has a system unit 14 to which is connected a user display 15, and input devices such as a keyboard 16 and a mouse 17.

Software running in each system unit 14 enables a user to send print jobs via the network 8 to one or more of the printers 10,11,12. The software includes printer drivers and a management information base (MIB) that describes each of the printers' 10,11,12 print capabilities. The print capabilities include both configurable and non-configurable features of the printer. An example of a configurable feature of a printer would be a paper tray which can be loaded with either A4 size or A3 size paper. An example of a non-configurable feature would be black and white laser printing capability or ink-jet colour printing capability.

The requirements of some print jobs may, or may not, be satisfied by the current printing configurations of one or more of the printers 2,3,4. The following description assumes that the printers 10,11,12 may need first to be either automatically or manually reconfigured in order to satisfy the printing requirements of a print job. However, the invention is applicable to the case where no reconfiguration is necessary.

The printers 2,3,4 may be configured by configuring each of a number of components. The most important components to configure are the input trays 21-26. When trays are empty, low on paper, or contain the wrong type of paper, then it may not be obvious to the operator which tray should be reconfigured with additional or different paper.

FIG. 2 describes the terminology used in this description of the invention. Each printer 10,11,12 will have its own Printer Configuration 30. The configuration can be determined in different ways, but a convenient method is to use a Management Information Base (MIB) 31, which is normally held within each printer 10,11,12. Alternatively, the MIB 31 may be held within one or more of the computers 14. The MIB 31 describes a Printer Profile 32, which can be decomposed into two parts: a Non-configurable Properties Profile 33 that describes Property Values 34 of the printer 10,11,12 that are effectively fixed and un-configurable; and a Configurable Component Profile 35, that describes Configuration Settings 36 of the printer 10,11,12 that can be re-configured, either automatically or manually.

The combination of the Property Values 34 and Configuration Settings 36 is a Set of Attributes 37 for the printer 10,11,12.

The Property Values 34 can be represented by a set with N elements denoted respectively as:

propertyX:pnameX;pvalueX X=1, 2, 3 . . . N

where for each non-configurable Property Profile 33, pname is a tag describing the property, and pvalue is a numerical value that is optional, and therefore shown in italic.

Similarly, The Configuration Settings 36 can be represented by a set with M elements denoted respectively as:

configurationY:pnameY; cvalueY Y=1, 2, 3 . . . M

where for each Configurable Component Profile 35, cname is a tag describing the configuration, and cvalue is a numerical value that is optional, and therefore shown in italic.

Some features (such as sheets of paper to print on, or the ability to hold paper, or the ability to print on paper of a given size) are fundamentally cumulative. For these, a set showing either presence or absence is an oversimplification.

A better approach is to represent such features by an explicit positive integer quantity for each member.

An example of a Configuration Setting 36 requiring a numerical value would be paper held in an input tray 21-26, where cvalue could be the number of sheets of paper left in the tray.

A Print Job 40 can be described in a similar manner. A computer system generating a Print Job 40 will in general generate as part of this a Job Ticket and/or Print Data 41 that can be used to derive Print Job Requirements 42 for that Print Job 40. A Job Ticket 41 may have the structure shown in FIG. 3, which shows data for a Xerox™ printer, as described in patent document U.S. Pat. No. 5,467,434. A Caxton Job Ticket, as shown in FIG. 4, looks rather different but amounts to much the same information.

A Job Ticket is an explicit representation of the job's requirements. With a Job Ticket the Print Job Requirements are deduced from this explicit representation.

In the case of Print Data 41, the Print Job 40 is analysed directly, although this is computationally more expensive than analysis of a Job Ticket. The Print Job 40 in this example consists of a set of instructions to the printer in a language known as a Page Description Language (PDL). This PDL can be parsed to separate it into its atomic instructions. Each of these instructions will implicitly make some requirements upon the printer 10,11,12. For example, an instruction to change the marking colour to “blue” followed by an instruction to print a character together, implies that the printer must have the ability to print “blue”. This needs to be transformed either into a requirement for colour printing capability, or into a requirement for spot-colour capability.

One of the computers 2,3,4 may conveniently be used to derive from the Job Ticket and/or Print Data 41 the Print Job Requirements 42 in the form of a Set of Features 47 for that Print Job, which must be satisfied by the Set of Attributes 37 if the Print Job 41 is to print correctly on one or more of the printers 10,11,12.

In a similar manner to that described above for the Set of Attributes 37, the Set of Features 47 can be represented by a set with P elements denoted respectively as:

featureZ:fnameZ;fvalueZ Z=1, 2, 3 . . . P

where for each feature of the Print Job Requirements 42, fname is a tag describing the feature, and fvalue is a numerical value that is optional, and therefore shown in italic.

FIG. 5 shows how a computer 2 can communicate with the printers 10,11 over the network 8, for example by SNMP messaging, to maintain a Printer Profile 32 in the computer that corresponds with the Management Information Base 41 in each printer.

FIG. 6 shows the decomposition 50 by the computer 10 of the Printer Profile 32 into the Non-configurable Properties Profile 33 and the Configurable Component Profile 35. In general, there may be a plurality of Configuration Component Profiles 35, one for each printer 10,11,12 on the network 8.

Consider now one example of how the Configurable Component Profiles 35 may be used with the Set of Features 47 for a Print Job 40. In general, each tray 21-26 can be configured independently. A printing need, like ‘green paper’ can be satisfied by configuring any one of a number of input trays 21-26. The combination of these two observations results in a classic NP-complete problem: SAT, the satisfiability problem of propositional calculus. Thus, the printer reconfiguration could be solved using well-known artificial intelligence techniques. Fortunately, for the vast majority of printer systems, the search space will be sufficiently small that a brute force search will be the best solution.

Referring now to FIG. 7, the raw data for determining how to reconfigure a printer comes from two sources: the printer's Management Information Base 31; and the print job's Job Ticket and/or Print Data 41. A MIB 31 structured according to the standard RFC1759 has many tables concerning components of the printer. The Job Ticket and/or Print Data 41 can have various formats, as illustrated in FIGS. 3 and 4. Therefore, although the raw data will in general have rather different formats, such data can always be processed to find a correspondence between the Set of Attributes 35 and Set of Features 47.

Because the Printer Profile 32 and Print Job Requirements 42 have been described in terms of sets, a correspondence between elements of each set is either present or absent.

If the Set of Features 47 for the Print Job 40 is a sub-set of the Set of Attributes 37 for the Printer Configuration 30, then the Print Job 40 can be printed on a printer 10,11,12.

More generally, for the sake of efficiency, it may not always be necessary to represent each feature or attribute in these sets.

Consider a specific attribute name-value pair. If such a pair is present at all times in all printers 10,11,12 in the printing system 1, then it can be ignored. Other pairs that can influence the printability of a Print Job 40 are significant and must be included.

Also for efficiency, the printers 10,11,12 should each be decomposed into their minimal, independently configurable, components. No feature should require two separate components to be configured correctly in order to be present.

Features should not make explicit reference to which component provided them (e.g. Tray 2 provides ‘Green A4 paper’ not ‘Green A4 paper in Tray 2’).

The Print Jobs themselves should be constructed in such a way that the Job ticket and/or Print Data 41 does not make explicit reference to printer components, which may require a more abstract way of encoding the Print Job Requirements 42.

It may also be helpful if Attributes 37 and Configuration Settings 36 (or Print Features 47) appear in the MIB 31 (or Job Ticket/Print Data 41) as name-value pairs. These may then be mapped by the computer 10,11,12 in the internal form as a single compound feature. For example, a media path may provide a name-value pair: “duplex” is one of “none”, “short-side” or “long-side”. Internally this should be mapped to three features: “simplex”, “duplex-short-side”, or “duplex-long-side”.

For a single media path it makes sense to say that if it is a simplex path then it is not a duplex-short-side path. The same is not true of a printer. The MIB 31 for a typical duplex printer declares that the printer has three media-path components: one simplex; one duplex-short-side; and one duplex-long-side. A Print Job 40 requiring any or all of these paths may have to be printed.

The nest step, is to iterate through the configurable components and to analyse them to find a set of a priori plausible reconfigurations. A plausible reconfiguration is one that is, in some way, related to the requirements of the job. For example, if the job needs some green paper, but no red paper, loading green paper into a paper tray is plausible, loading red paper into a tray is not.

A method of performing a reconfiguration analysis 52 for a particular component is to:

i) Iterate through the possible features that this component can provide, thereby constructing a collection of plausible reconfigurations.

ii) Then to iterate through the plausible reconfigurations evaluating

the cost of that reconfiguration

and the Set of Features 47 provided by such a reconfiguration.

This then results in a set of possible component reconfigurations 54, with each element 56 in the set being a plausible reconfiguration with an associated reconfiguration cost.

One way to perform this analysis 52 is in step i) to initialise a computer program by setting the collection of plausible configurations to be a collection with one element, that being the current configuration. The iterative step ii) would then proceed as follows:

for each such feature

if it is not a member of the Set of Features 47, skip further consideration of this feature

add to the collection of plausible configurations all configurations of this component that provide this feature.

The set of all features that this component can provide, and the mapping from such a feature to the configurations that provide it can be provided by a simple technique such as a look-up table.

It is to be noted that this step relies on an adequately fine-grained partitioning of the system into components so that each component has only a small number of different reconfigurations that can provide any different feature.

If this is not true then it may be necessary either to:

a) Redesign the Set of Features 47, or the decomposition of the printer into its components 33,35. or

b) Modify this step ii) to be more restrictive in its notion of plausible.

The step ii) above evaluates the plausible configurations, both for their costs, and for the features provided. The Set of Features construction is done in a similar manner to that for the non-configurable profile transformation.

The cost is evaluated by estimating the financial cost of making such a reconfiguration. One way in which this estimation can be done is first to take the current configuration as having zero cost. It does not cost anything to leave things how they already are. A fully automatic reconfiguration will in general have a negligible cost. Operator conducted operations have a cost in proportion to the operator time required.

In the case of configurations for which the act of reconfiguring the system uses up some resource other than operator time, with non-negligible cost, these costs should be taken into account.

The costs of each configuration step are estimates. In most cases, the method of choosing a reconfiguration is relatively robust against these estimates being incorrect.

Therefore, it is generally not effective to spend a great effort in making these estimates very precise.

For components with only a small range of reconfigurations, these cost estimates can be listed in lookup tables.

As an example, each reconfiguration of an input tray 21-26 has four distinct operator actions, all of which may not be needed. These are:

1. Unload the current paper, if any.

2. Change the paper guides for the new paper size, if it differs from the current size.

3. Load the new paper if different from the current paper.

4. Reload new paper each time it gets exhausted during printing of the print job.

These costs are estimated by having fixed costs for each item, and summing those costs that apply. The cost of reloading needs to be taken into account for each reload needed.

Consider the case where a job requires 450 green sheets of A4 paper, and a printer has a 200 sheet capacity tray currently loaded with 70 sheets of A4 green paper.

Plausible reconfigurations of this tray are ones involving: 0 or 1 paper loads, and 0, 1 or 2 paper reloads. These six reconfigurations will have different costs and provide different quantities of green paper, ranging from 70 to 600 sheets. In contrast, a 2000 sheet capacity tray, currently loaded with A3 paper, has one plausible reconfiguration involving an Unload, a Size Change and a Load.

Once the iterations described above have been performed, a search can be performed of the various reconfigurations and costs. It will generally be the case with printing systems that the search space is small enough that a brute force search can be performed in a reasonable amount of time.

Once the search has been performed, the results can be presented to a user of the system on one of the computer displays 15. FIGS. 8 and 9 show two ways in which the information can be presented. In FIG. 8, one or more lowest cost reconfigurations 58 of one or more components is presented to a user on the display 15 in the form of reconfiguration instructions 59. The user can then select a recommended reconfiguration, which may be the lowest cost reconfiguration.

Optionally, the user can select a reconfiguration that is not the very lowest cost, but one which has a low cost.

This may be desirable if the user is more comfortable performing one type of manual reconfiguration over another type of manual reconfiguration.

In FIG. 9, no reconfiguration information is presented to a user. This may be because no reconfiguration is necessary, or because any necessary reconfiguration is automatic, and can therefore be done without the need for the user to be informed of such a reconfiguration. The user is presented with information on a display 15 describing one or more print options in which the print job is assigned across one or more of the printers. The information includes a cost breakdown 60. The user can then select amongst the presented print options. Usually, the user will select the lowest cost assignment, but again may optionally select a print assignment that is not the very lowest cost, but which has a low cost.

As has been indicated above, a print job may be assigned to more than one printer—typically, split between two or more printers according to their capabilities. If this is done, the printing system may present to a user of the printing system instructions for any or all of locating, assembling, collating, binding, or otherwise combining material printed from the printers. This helps to lower the economic cost of splitting a print job or jobs across a plurality of printers.

One reason why it might be desirable to split a print job, is when the print job has a plurality of different parts, and each part has different printing requirements. The print job can then be split according to those different requirements.

The invention therefore provides a system and a method that facilitates the assignment, and optionally also the reconfiguration, of one or more printers connected to a computer system so that the printers match the requirements of a print job generated by the computer system in a cost effective way.

1. A method of assigning a print job in a printing system, the printing system comprising at least one printer and at least one computer connected to said printer(s), wherein the or each printer has a plurality of different printing configurations and the or each computer is capable of generating at least one print job, said print job(s) having corresponding printing requirements, each printing configuration being capable of satisfying one or more printing requirements, the method comprising the steps of:
i) creating one or more print jobs;
ii) notionally assigning the or each print job across one or more of the printers in such a way that the one or more of the printers have printing configurations that are capable of satisfying the printing requirements;
iii) calculating a cost for printing the or each print job according to said notional assignment;
iv) repeating steps ii) and iii) at least once for a different notional assignment; and
v) selecting according to the calculated costs a preferred assignment of the or each print job.

2. A method as claimed in claim 1, in which the or each printer has a pre-existing printing configuration, and said calculation of the cost includes an assessment of the cost of any needed changes from the pre-existing configuration(s) to changed configuration(s) so that the printer(s) can satisfy the printing requirements.

3. A method as claimed in claim 2, in which said needed changes include manual reconfiguration of at least one printer, said calculated cost then including an assessment of the cost of such a manual reconfiguration.

4. A method as claimed in claim 3, in which the preferred assignment of the printing job requires a manual reconfiguration of at least one printer, in which the printing system after selection of said preferred assignment then presents to a user of the printing system instructions for manually reconfiguring said printer(s).

5. A method as claimed in any preceding claim, in which the print job is assigned to more than one printer, and the printing system presents to a user of the printing system instructions for any or all of locating, assembling, collating, binding, or otherwise combining material printed from the printers.

6. A method as claimed in any preceding claim, in which the print job has a plurality of different parts, each part having different printing requirements, and the print job is split according to those different requirements.

7. A method as claimed in any preceding claim, in which the calculated cost is an economic cost.

8. A printing system, the printing system comprising at least one printer and at least one computer connected to said printer(s), the or each printer having a plurality of different printing configurations and the or each computer being capable of generating at least one print job, said print job(s) having corresponding printing requirements, each printing configuration being capable of satisfying one or more printing requirements, wherein the printing system is arranged to calculate a cost for printing the or each print job according to different notional assignments of the or each print job across one or more of the printers in such a way that said printers have printing configurations that are capable of satisfying the printing requirements, and to select according to the calculated costs a preferred assignment of the or each print job.

9. A method of assigning a print job in a printing system substantially as herein described, with reference to or as shown in the accompanying drawings.

10. A printing system substantially as herein described, with reference to or as shown in the accompanying drawings.
